(19) United States
(12) Patent Application Publication
(10) Pub. No.: US 2008/0153511 A1
(43) Pub. Date: Jun. 26, 2008

(54) Method of Receiving a Special Privilege Based Upon Attendance and Participation in an Event

(75) Inventor: Von A. Mock, Boynton Beach, FL (US)

Correspondence Address: MOTOROLA;c/o DARBY & DARBY PC, P.O. BOX 770, CHURCH STREET STATION, NEW YORK, NY, 10008-0770, US

(73) Assignee: MOTOROLA, INC., Schaumburg, IL (US)

(21) Appl. No.: 11/615,482

(22) Filed: Dec. 22, 2006

(51) Int. Cl. H04Q 7/20

(52) U.S. Cl. 455/456.3

(57) ABSTRACT

A method of receiving at least one special privilege based upon an attendee's (101) attendance and participation in an event (100) at the geographic location and time of the event (100). The at least one special privlege is received by the attendee (101) from the event sponsor (102) as an incentive to attend and participate in the event (100). A digital media such as a digital rights management (DRM) object (123) is associated with the at least one special privilege which is delivered to a DRM device (120) when the attendee (101) is at the location and time of the event (100). The at least one special privilege associated with the DRM object (123) can be retrieved directly from the DRM device (120). Alternately, the DRM object (123) can be used to retrieve the at least one special privilege from another source.

### BACKGROUND OF THE INVENTION

1. Statement of the Technical Field

The invention relates to a method of receiving at lest one special privilege based upon a person's attendance and participation in an event. More particularly, this invention relates to a method of receiving at least one privilege by an event sponsor delivering to the person a Digital Rights Management (DRM) object associated with the at least one special privilege as a reward for attending and participating in the event at the location and time of the event.

2. Background of the Invention

In recent years, the cost of attending special events such as concerts, sporting events, and other performances has steadily risen. As a result, the apparent value to consumers is diminishing and consumers have been forced to consider whether the cost of attending the event is worth it. With most events and performances now available for viewing live on television, consumers may choose to just watch the event at home or at some other remote location. Thus, event sponsors have been forced to consider other incentives to encourage consumers to attend the event at the location of the event rather than watch the event on television or to miss the event entirely. One incentive considered by event sponsors is to offer a person who purchases a ticket for and attends the event a special privilege associated with the event. The special privilege would not be available otherwise to others who do not attend the event at the location and time of the event.

There are several problems associated with an incentive system such as this. One problem is how to distribute the special privilege to the appropriate individuals who actually attend the event at the location and time of the special event. Such an incentive system is ripe for abuse by individuals who may want to receive the special privilege but who do not want to pay for or attend the event. One way to control this problem is to only distribute the special privilege to those who attend the event at the location and time of the event. However, even those who attend the event at the location and time of the event may still give away the special privilege distributed to them when they attended the event. Thus, there exists a need for distributing the special privilege to a person who purchases and attends an event at the location and time of the event and ensuring that the special privilege can only be used by that person.

One other problem associated with such an incentive system is distributing unique special privileges from the event sponsor to persons who attend a particular event rather than the same special privilege being distributed to persons for different events. Further a plan sponsor may want to distribute unique special privileges to various persons attending the same event rather than every person at the event receiving the same special privilege. The distribution of special privileges to respective persons could be based upon some predetermined scheme or be done at random.

In view of the forgoing, there remains a need for a method of providing a person an extra incentive and encouragement to purchase a ticket for and participate in the event at the location of the event at the time of the event. Some of the incentives have included special privileges that have been encoded on a digital media.

In recent years, there have been systems that use digital rights management (DRM) techniques to control the distribution of digital media over a computer network or through other digital media. DRM is a technology that content owners can use to protect their contents by limiting access to the contents to those persons who have acquired a license to use the contents.

For example, US patent application serial no. 2006/123484 A1 discloses a method for clearing and delivering digital rights management (DRM) licenses to websites and Internet protocol (IP) connected devices. The method utilizes one or more web services to receive one or more license requests from devices connected by IP networks and generates, clears and delivers licenses containing license keys and rights or rules that govern the use of one or more digital media file or live broadcast. Use of a web service unifies numerous complex steps and insures proper interface between otherwise potentially incompatible software and hardware modules which may be distributed at various remote locations. License clearing and delivery may then be performed seamlessly and transparently to a virtually unlimited number of devices connected by IP networks.

In U.S. patent application serial no. 2006/0117391 A1, there is a method and apparatus for processing digital rights managements (DRM) contents having advertisement (AD) contents attached thereto in a DRM system. When the DRM contents including AD contents are selected by a DRM device, a rights issuer (RI) receives the AD contents and the DRM contents from a contents issuer (CI), generates a multipart contents format file, and downloads it to the DRM device. Then, the DRM device decodes the downloaded multipart contents format file to check whether the multipart contents format file includes AD contents-attached DRM contents, and if so, the DRM device reproduces the AD contents to use the DRM contents free of cost. Thus, the DRM contents can be provided to a user by using the AD contents without causing a burden of a charge.

However, none of these systems provide a method of delivering a person a special privilege associated with a digital media such as a digital rights management (DRM) object based upon the person's attendance and participation in the event at the location and time of the event. In view of the foregoing, there remains a need for a method of providing a special privilege associated with a DRM object to a person who attends an event at the location and the time of the event.

### SUMMARY OF THE INVENTION

The invention concerns a method for receiving at least one special privilege based upon a person's attendance and participation in an event at the geographic location and time of the event. The at least one special privilege is received by the attendee of the event from the event sponsor as an incentive to attend and participate in the event. A digital media is associated with the at least one special privilege which is delivered to a mobile digital rights management (DRM) device when the attendee is in the geographic location of the event at the time of the event.

The method is comprises of the steps of an event sponsor planning an event and offering a special privilege to an attendee for attending the event at a geographic location and time of the event, the attendee purchasing from the event sponsor rights to attend the event, the event sponsor storing data related to the attendee's purchase of the rights to attend the event including the identify of the attendee and a mobile device associated with a unique identifier in a database of a host computer connected to a computer network, the event sponsor assigning a digital media to the attendee associated with the special privilege and the unique identifier of the mobile device, the attendee attending the event at the location and time of the event, the attendee bringing the mobile device to the event, the event sponsor using the host computer and data from the database to detect the presence of the mobile device at the event, identifying and verifying the identity of the attendee and the unique identifier of the mobile device, and transmitting to the mobile device the digital media.

The method further includes the step of the attendee retrieving the digital media from the mobile device associated with the at least one special privilege.

The mobile device is selected to be a personal digital assistant, palmtop, or cellular telephone. The mobile device selected includes a microprocessor and a datastore for receiving the digital media. In addition, the at least one special privilege is selected to be a selected musical recording, a live recording of the event, a ring tone, discounts for similar events, player profiles, game statistics, or special abilities in an on-line game. Alternately, the digital media includes a coupon or code for retrieving the at least one special privilege from a source other than the mobile device. The method includes the step of including in the digital media rights associated with attendee's use of the at least one special privilege.

The host computer is used to detect the mobile device when the attendee is at the location of the event at the time of the event. The host computer can be disposed in the proximity of the event or at some other remote location. The host computer is connected to a wireless access point to interface with the mobile device. Once the mobile device is detected, the host computer can transmit the digital media to the mobile device.

In an alternate embodiment of the invention, a media reader located at the entrance or other location at the event is connected to the host computer is used to scan a unique identifier on a ticket to notify the host computer attendee is at the location and time of the event. The digital media can then be transferred to the mobile device at a selected time. The unique identifier is selected to be a bar code or a radio frequency (RFID) tag. The media reader is selected to be a bar code reader or a RFID reader.

In another aspect of the invention, a mobile wireless device is provided comprising a processor and software application interfacing with a remote computer exclusive of the wireless mobile electronic device. The remote computer wirelessly automatically downloads a digital media to the wireless mobile device at a geographic location of an event. The mobile wireless device comprises a data store for storing the digital media. The mobile wireless device further comprises a unique identifier associated exclusively with the mobile wireless device. The unique identifier includes an international mobile equipment (IMEI) number, a serial number of the mobile wireless device, and a cellular telephone number assigned to the mobile wireless device. The mobile wireless device is a member of the group consisting of a personal digital assistant, a wireless mobile telephone handset, and a personal computer.

### BRIEF DESCRIPTION OF THE DRAWINGS

Embodiments will be described with reference to the following drawing figures, in which like numeral represent like items throughout the figures, and in which:

FIG. 1 is a block diagram of an example environment of use and an exemplary system utilized for delivering a digital media to an event attendee when the attendee is at the location and time of an event.

FIG. 2 is a block diagram of another embodiment of an example environment of use and an exemplary system utilized for delivery a digital media to an event attendee when the attendee is at the geographic location and time of an event.

FIG. 3 is a flow diagram of a method of delivering a digital media to an event attendee utilizing the system shown in FIG. 1.

### DETAILED DESCRIPTION OF THE PREFERRED EMBODIMENTS

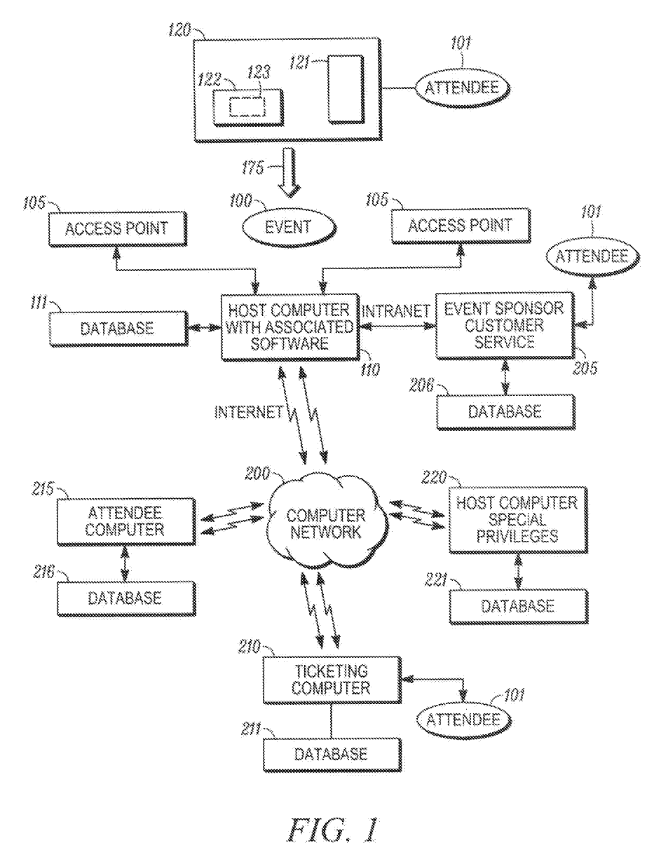

Referring now to FIG. 1, shown is a block diagram of an example environment of use and an exemplary system utilized for allowing one or more attendees 101 of an event 100 to receive at least one special privilege when the attendees 101 are at the geographic location and time of the event 100. An event sponsor 102 may wish to distribute the at least one special privilege as an incentive for attending and participating in the event 100. The at least one special privilege could be a digital media such as a digital rights management (DRM) object 123 delivered to each attendee 101 at the location and time of the event 100. In the exemplary embodiment, the event 100 may comprise any type of event such as a concert, sporting event, or other performance.

A DRM object 123 is a digital media using digital rights management (DRM) technology to control the distribution and access to the content of the digital media. DRM is any of several technologies that digital media content owners can use to control access to and usage of the digital data (such as software, music, movies) and hardware, and any usage restrictions associated with a special digital media content. Previously, Digital Rights Management (DRM) focused on security and encryption as a means of solving the issue of unauthorized copying. The digital media content is locked and its distribution limited to only those who pay. This was the first-generation of DRM, and it represented a substantial narrowing of the real and broader capabilities of DRM. The second-generation of DRM covers the description, identification, trading, protection, monitoring and tracking of all forms of rights usages over both tangible and intangible assets including management of rights holders relationships. The DRM object 123 of the present invention uses DRM technology of the second generation to control the distribution and access to the digital media associated with the at least one special privilege.

The DRM object 123 is wirelessly downloaded from a computer 110 hosted by the event sponsor 102 to a mobile digital rights management (DRM) device 120 carried by each attendee 101 to the event 100. In FIG. 1, the arrow 175 represents the attendee 101 bringing a DRM device 120 to the geographic location of an event 100. The DRM device 120 could be a personal digital assistant (PDA), personal computer such as a palmtop, cellular telephone handset, or other wireless device having a microprocessor and datastore 121 for receiving and storing the DRM object 123. The DRM device 120 used must be capable of interfacing with a computer 110 which could be located at the location of the event 100 or at a remote location.

The computer 110 is connected to at least one wireless access point 105 (WAP) and has associated software for interfacing with the DRM device 120 within the reception area of the at least one access point 105. The at least one access point 105 could be located at the entrance of the location of the event 100 or spaced strategically throughout the location of the event 100 to define an area of maximum reception for the DRM device 120 carried by the attendee 101. The at least one wireless access point 105 could be part of a wireless local area network (WLAN) for portable wireless devices such as a PDA or a palmtop. The at least one wireless access point 105 could be part of a wireless wide area network (WWAN) for connectivity to cellular phones. There could be at least one wireless access point 105 for each of a WLAN and a WWAN so that the DRM device 120 brought by the attendee could be either a portable device such as a PDA or a cellular telephone. However, this is not limiting as any type of wireless network or combination of wireless networks could be used to connect the DRM device 120 to the computer 110.

The DRM device 120 must also be able to interface with the computer 110 so that the DRM object 123 can be wirelessly transmitted from the computer 110 to the DRM device 120 via the at least one access point 150. Any of the known wireless protocols can be used to transmit the DRM object 123 from the computer 110 to the DRM device 120. It is also desirable that the data transmitted be encrypted to prevent the receipt of and use of DRM objects 123 by unauthorized users. Preferably, a DRM device 120 will have a software application running in the background for interfacing with computer 110 and receiving and decrypting the DRM object 123.

The DRM device 120 must have or be capable of being programmed with a unique identifier so that the computer 110 can identify and verify the identity of the DRM device 120 before the DRM object 123 is downloaded. Most mobile wireless devices are configured with an embedded electronic serial number which could be used as a unique identifier. For example, cellular phones are configured with an International Mobile Equipment Identity (IMEI) number which could be used as a unique identifier. Alternately, the cellular telephone number assigned by the cellular carrier to the cellular phone could be used. If the DRM device 120 does not have an embedded electronic serial number that could be used as a unique identifier, then a confirmation number received at the time of the purchase of the ticket to the event 100 must be entered into the DRM device 120 to be used as the unique identifier.

The computer 110 has an updatable database 111 for storing data for ready retrieval by computer 110. The data stored and updated in databases 111 can include the names, dates and times and other data related to the event 100. Other data stored can include cumulative data related to the upcoming attendees 101 of each scheduled event 100 including but not limited to the names and addresses of the attendees 101, a unique identifier associated with the DRM device 120 that will be carried by each attendee 101, any preferences of each attendee 101 with respect to the special privileges offered by the sponsor 102, and a DRM object 123 associated with the special privileges to be granted to the attendee 101 at the location and time of the event 100.

There are many ways in which the computer 110 can be configured to detect the DRM device 120 at the location and time of each event 100. In one embodiment of the invention, the computer 110 could be programmed to poll for the unique identifier associated with each DRM device 120. The unique identifier for each attendee 101 could be stored in the updatable database 111 and polled for during selected times the attendee 101 is supposed to be at a selected event 101. In another embodiment of the invention, each DRM device 120 could have an application running in the background which sends the unique identifier and location information to the computer 110.

The computer 110 and updatable database 111 could also be used to host the special privileges being retrieved by the attendee 101 after the attendee 101 has received the DRM object 123. Further, the computer 110 and updatable database 111 could be used to track which attendees 101 have used their special privileges and when the expiration period to use the special privileges has expired. When used in this capacity, the special privileges could be hosted on a remote computer 215 with the use of the special privileges being controlled by computer 110 over a computer network 200 as discussed further herein below.

The computer 110 interfaces with a computer network 200 configured for transferring digital data between one or more remote computers 210, 215, and 220. The computer network 200 can be the Internet or other computer network that is known to one of ordinary skill in the art. The digital data includes data related to the event 100 such as the name of the event 100, the time and location of the event 100, and data related to the attendee 101 such as the name of the attendee 101, the unique identifier associated with the attendee 101 and the DRM device 120, payment for the event 100 by the attendee 101, and the DRM object 123. The computer 110 could also interface with a computer 205 and updatable database 206 hosed by the event sponsor 102 over a computer connection such as an Intranet hosted by the event sponsor 102.

Each of the computers 205, 210, and 215 can allow an operator to access information related to the event 100 including the name of the event 100, time and location of the event 100, and at least one special privilege as an incentive for attending the event 100 associated with the DRM object 123. The operator may also input information related to the attendee 101 attending and purchasing the rights to attend event 100 such as the attendee's name, address, the unique identifier associated with the DRM device 120 owned by the attendee 101, any preferences with respect to the at least one special privilege being offered by the event's sponsor 102 for attending the event 100, and payment information by the attendee 101 for the rights to attend and participate in the event 100.

The operator could be a customer service representative employed by the event sponsor 102 who receives the related data from the attendee 101 over the telephone and enters it into the computer 205 and updatable database 206.

The operator could be a customer service representative who is employed by a third party ticketing agency who has an affiliation with the event sponsor 102. The operator can access the information related to the event 100 and enter information related to the attendee 101 in the computer 210 and updatable database 211.

The operator could be the attendee 101 who accesses a website hosted by the event sponsor 102 on computer 110 through a computer network 200 such as the Internet. The website is accessed by a computer 215 hosed by the attendee 101. The website could contain information related to one or more events 100 hosted by the event sponsor 102 including the names of the events 100, locations and times of the event 100, at least one special privilege offered to the attendee 101 for attending and participating in the events 100, payment information, and how to gain access or retrieve the at least one special privilege associated with the DRM object 123 received by the DRM device 120 at the location and time of the event 100.

After the operator has entered the related data into the respective computers 205, 210 and 215, the related data is transferred to the host computer 110 and updatable database 111 by the computer network 200 or the event sponsor 102 Intranet. The related data is used by computer 110 to detect the DRM device 120 carried by the attendee 101 at the location and time of the event 100 and to distribute the DRM object 123 to the DRM device 120.

The at least one privilege could be hosted on a remote computer 220 and updatable database 221 that is accessed by the attendee 101 through the computer 215 over the computer network 200. The attendee 101 could enter the DRM object 123 into computer 215 which accesses the host computer 110 via computer network 200 to verify the identity of attendee 101 and that the attendee 101 is entitled to access at least one special privilege hosted on the computer 220. Once verification has been given by the computer 110 to the computer 220, the attendee 101 can access the at least one special privilege hosted on the computer 220 via the computer network 200.

The DRM object 123 is associated with the at least one special privilege that can be accessed or retrieved by the attendee 101 after the attendee 101 has attended or participated at the event 100 at the location and time of the event 100. It is envisioned that the special privileges would be related to the content of the event 100 but this is not meant to be limiting.

For example, if the event 100 is a concert, a DRM object 123 that could be downloaded to the DRM device 120 could be an audio recording of music selected by the attendee 101, or a live recording of the concert. Only those attendees 101 who attended the concert live would receive the DRM object 123. The DRM object 123 could also later be used to download a copy of favorite song or the live recording of the concert. The DRM object 123 could be a unique code that is delivered to each DRM device 120 and is retrieved from the display 121 of the DRM device 120. The code could then be entered into a special field on an Internet web site hosted on computer 110 by the event sponsor 102. Once the code is received by the computer 110 hosting the web site, the attendee 101 could download the favorite song or live recording of the concert onto the attendee's computer 220. The attendee 101 could then store the downloaded media on the updatable database 221, a CD, DVD, MP3 or other storage media.

Alternately, the code could be taken to a music store where copies of the live recording have been distributed on CD, DVD and other formats. The code could be entered into the music store's computer (not shown) to verify that the attendee 101 is eligible to receive a copy of the live recoding. Only after acceptable proof of identification will the attendee 101 receive the copy of the live recording and/or a discount associated with the code.

The DRM object 123 could be a digital code that is uploaded to a computer such as the computer 215 hosted by attendee 101 through a port such as a universal serial bus (USB) port and cable, infrared (IR), or by wireless connectivity using any of the known wireless protocols known by one with ordinary skill in the art. However, the method of connectivity is not limiting in that any method of connectivity can be used including those that may be developed in the future. Once the DRM object 123 is uploaded to computer 215, the DRM object 123 can be transmitted over the computer network 200 such as the Internet to the event sponsor's 102 host computer 110 and database 111. The host computer 110 may also require verification of the unique identifier associated with the DRM device 120. The live recording of the concert can then be downloaded by computer 215 onto database 216 or other media including CD, DVD or an MP3 device.

Alternately, the DRM object 123 could be an electronic coupon that is uploaded to computer 215. Once uploaded, the electronic coupon is printed and taken to a music store to retrieve the copy of the live concert or a discount associated with the coupon.

Other examples of events where a DRM object 123 could distributed as an incentive for attendance include sporting events. A DRM object 123 could be associated with a special privilege related to the sporting event. Specifically, as an incentive to purchase and attend a football, basketball, baseball, soccer or other sporting event, an event sponsor 102 could grant the attendee 101 a special privilege with respect to competing against others in on-line games. There are many popular on-line games simulating the play of football, basketball, baseball, soccer or other sporting events. Many of these on-line games mimic the names of various football teams and players on these teams. The special privilege could be giving the attendee 101 special abilities which others participating in the on-line game do not have because they did not attend the event 100.

Other DRM objects 123 could be associated with other types of special privileges such as mementos of the event 100 attending including tickets, brochures, player pictures and profiles, ring tones, game statistics, and advertising and discounts for the next similar event 100. The special privileges could include incentives that are accumulated by the attendance of attendee 101 at two or more selected events. Specifically, the special incentives could be cumulative in that more special privileges are given for each subsequent attendance by attendee 101 at selected events 100. For example, an attendee 101 could accumulate greater privileges as an incentive for the attendance of all of the games of a season of the sporting event. The special privileges could be any of the aforementioned special privileges or another selected special privilege in addition to accumulated special privileges.

The DRM object 123 could also contain other information related to the digital rights to access the at least one special privilege. For example, the DRM object 123 could be encoded to prevent the DRM object 123 from being copied from the DRM device 120 to another digital media. The DRM object 123 could be encoded with the number of times an attendee 101 can access the at least one special privilege such as the number of times the attendees can play the downloaded media or play the on-line game. The DRM object 123 could be encoded with the number of times a media could be transferred, downloaded or copied to a another media such as computer 215 or to a media such as a CD or DVD. The DRM object 123 could be encoded with a special privilege start date and expiration date. The DRM object 123 could also be encoded with encryption information related to connectivity of the DRM device 120 to the computer 110.

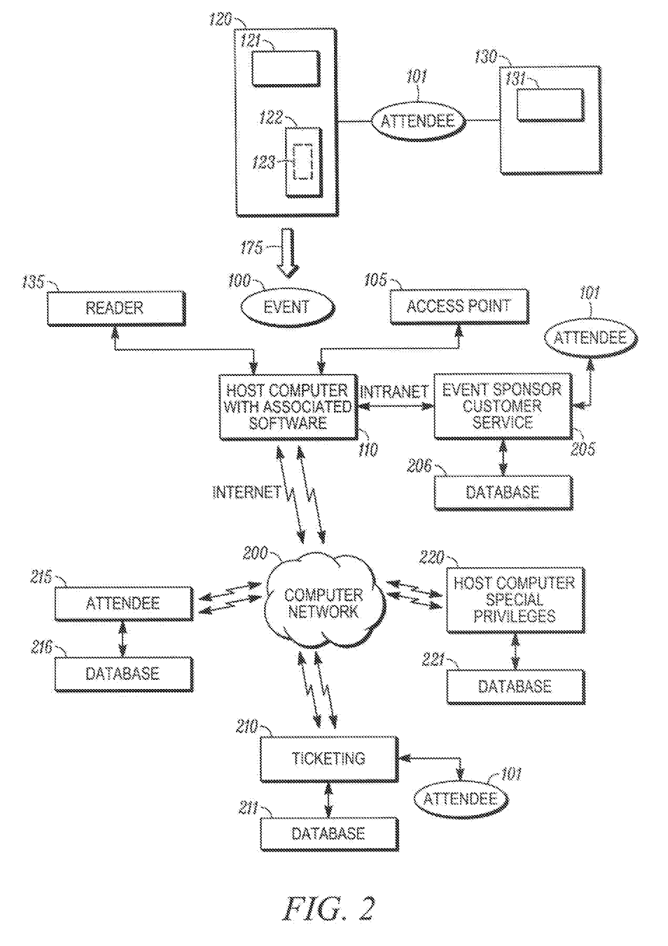

Referring now to FIG. 2, shown is a block diagram of another embodiment of an environment of use and an exemplary system utilized for allowing one or more attendees 101 of an event 100 to receive at least one special privilege when the attendees 101 are at the location and time of the event 100. The environment of use and exemplary system is identical to the environment and system shown in FIG. 1 except for the method by which the host computer 110 is notified that attendee 101 is at the location and time of the event 100. The arrow 175 represents the attendee 101 bringing a DRM device 120 to the geographic location of the event 100.

Specifically, the at least one special privilege could be associated with a unique identifier 131 such as a UPC bar code printed on a ticket 130 issued for the event 100. The unique identifier 131 could be read by a media reader 135 such as a bar code reader that is located at the entrance to the event 100. Once the unique identifier 121 is read by the media reader 135, the computer 110 could be notified that the attendee 101 is at the event 100. The unique identifier 131 could contain other related information related to the purchase of the ticket 130 to the event 100 by the attendee 101. Such related information could include the identity of the attendee 101, the name, time, date and location of the event 100, a unique identifier associated with a DRM device 120 carried by attendee 101, and at least one special privilege extended by the event sponsor 102 as in incentive for attendee 101 attending the event 100. Such information could be collected from attendee 101 by the event sponsor 102 at the time of the purchase of the ticket 130. Such information could also be stored in updatable database 111 of computer 110 at the time of purchase for later retrieval when the unique identifier 131 is read by the media reader 135.

Alternately, ticket 130 could contain a unique identifier 131 such as a radio frequency identification (RFID) tag encoded with the related information. The media reader 135 connected to computer 110 located at the gate of the event could be an RFID reader for reading the unique identifier 131 and notify computer 110 that attendee 101 is at the location of the event 100. Alternately, the media reader 135 could be located at some other location at the location of the event 100. The computer 110 could be programmed to search for the unique identifier 131 for selected attendees 101 only during selected times during selected events 100 to notify computer 110 that attendee 101 is at the location of the event 100. Once the computer 110 has been notified that attendee 101 is at the event 100, the related information could then be transmitted to computer 110.

When computer 110 is notified that attendee 101 is at event 100, the DRM object 123 associated with the at least one special privilege can be downloaded to the DRM device 120 via the at least one access point 105. The DRM object 123 could be immediately downloaded or downloaded at selected times during the event 100. For example, the DRM object 123 could be a coupon immediately downloaded to a DRM device 120 carried by the attendee 101 after the attendee 101 has passed through the gates of the event 100 at the time and location of the event 100. The coupon could contain a code which can be used for later retrieval of the at least one special privilege in a manner previously discussed. The code could contain related information related to the use of the at least one special privilege by the attendee 101.

Alternately, the DRM object 123 such as the coupon could be downloaded to the DRM device 120 at a selected time during the event 100. The DRM object 123 could also be any type of digital media given as an incentive for attending the event 100 such as those previously discussed.

In another embodiment of the invention, the ticket 130 could be issued to the attendee 101 that is encoded with a unique identifier 131 such as a bar code or RFID tag containing related information to attendee's 101 attendance at a selected event 100. The related information could also be stored in the computer 110 hosted by the event sponsor 101. The unique identifier 131 could contain information related to at least one special privilege granted by the event sponsor 102 to attendee 101 as an incentive to attendee 101 to attend and participate in the event 100. The unique identifier 131 could be scanned at the gate of the event 100 by a media reader 135 to notify computer 110 by attendee's 101 presence at the event 100. The computer 110 could then verify the identity of the attendee 101 and the at least one special privilege to be delivered to the attendee 101 from the event sponsor 102. A printed coupon could then be issued to the attendee 101 for use in later retrieving the at least one special privilege. The coupon could contain a code uniquely identifying the attendee 101 when the attendee 101 attempts to retrieve the at least one special privilege in a manner previously described.

Alternately, other types of at least one special privilege could be given to the attendee 101 at the gate of the event 100 which could include any type of memorabilia, advertising, or other benefit associated with the attendance at the event 100.

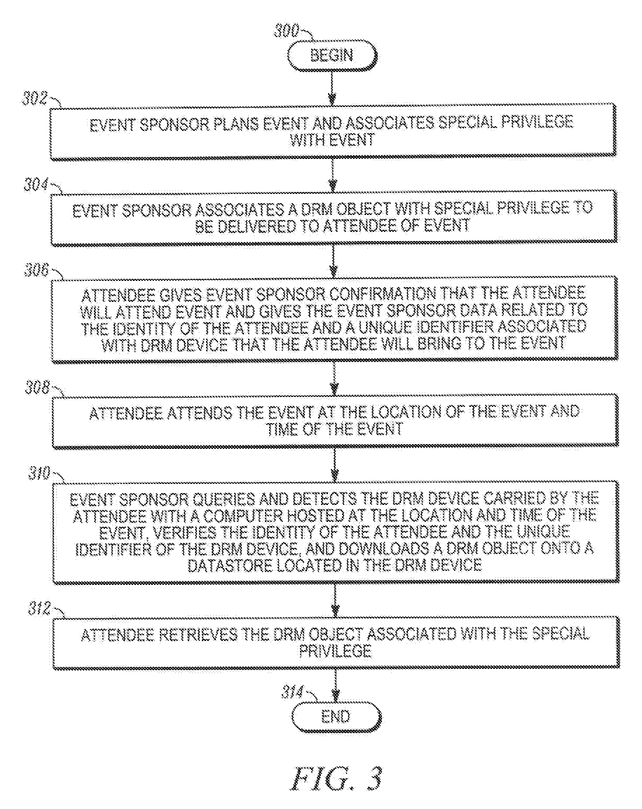

Referring now to FIG. 3, shown is a flow diagram of a method of delivering at least one special privilege to an attendee 101 when the attendee 101 is in the location of the event 100 at the time of the event 100. The method begins with step 300 and continues with step 302.

In step 302, an event sponsor 102 plans an event 100 and associates at least special privilege which the sponsor 102 intends to deliver to an attendee 101. The at least one special privilege is to be received by attendees 101 who attend the event 100 at the time and location of the event 100.

In step 304, the event sponsor 102 associates the at least one special privilege with a DRM object 123 which is to be delivered to the attendee 101 when the attendee 101 attends the event 100. Data related to the DRM object 123, the event 100 and associated at lest one special privilege are entered into an updatable database 111 of a host computer 110. The DRM object 123 is for delivery to a mobile DRM device 120 which is carried by the attendee to the event 100. The attendee 101 uses the DRM device 120 to retrieve the DRM object 123 associated with the at least one special privilege during or after the event 100.

In step 306, the attendee 101 gives the event sponsor 102 confirmation that the attendee 102 will attend the event 100 and gives the event sponsor 102 related information to the identity of the attendee 101, a unique identifier associated with the attendee 101 and a DRM device 120 that the attendee 101 will bring to the event 100, payment information, and any preferences with respect to the at least one special privilege desired by the attendee 101.

The confirmation and related information can be given by the attendee 101 telephoning an employee of the event sponsor 102. The confirmation and related data are entered into a computer 205 and updatable database 206 hosted by the event sponsor 102. The confirmation and related data are further transmitted to computer 110 and updatable database 111.

The confirmation and related information can be given by the attendee 101 over the telephone to an operator employed by a third party ticketing agency. The third party ticketing agency enters the confirmation and related information into a remote computer 210 and updatable database 211. The confirmation and related information is transmitted from the remote computer 210 and updatable database 211 over the computer network 200 to the computer 110 and updatable database 111.

The confirmation and related information can be given by the attendee 101 to the event sponsor 102 by the attendee entering the confirmation and related information at website hosted by the event sponsor computer 110. The attendee 101 can access the website through a remote computer such as computer 215 hosted by the attendee 101 over a computer network 200 connected to the event sponsor computer 110. The confirmation and related information is updated in the event sponsor database 111.

In step 308, the attendee 101 attends the event 100 at the location and time of the event 100. The attendee 101 carries the mobile DRM device 120 to the event 100.

In step 310, the event sponsor 102 detects the DRM device 120 carried by the attendee 101 with a computer 110 hosted at the location of the event 100, verifies the identity of the attendee 101 by the unique identifier of the DRM device 120, and downloads a DRM object 123 onto a datastore 121 located in the DRM device 120. The DRM object 123 is associated with the special privilege granted to the attendee 101 for attending the event 100. The unique identifier of the DRM device 120 is verified to ensure that the correct DRM object 123 is downloaded to the DRM device 120.

In step 312, the attendee 101 retrieves at least one special privilege associated with the DRM object 123. The at least one special privilege can only be retrieved after the DRM object 120 has been downloaded to the DRM device 120. The DRM object 123 is only downloaded to the DRM device 120 after the attendee 101 has attended and participated in the event 100. This means that some types of special privileges may be received at the event 100 after the DRM object 123 has been downloaded. For example, if the special privilege is a song, the song may be played on the DRM device 120. Other types of special privileges may require that the attendee 101 wait to retrieve the special privileges at a later time. Examples of these types of special privileges include using the DRM object 123 to obtain a copy of a recording of the live event or special abilities in on-line gaming as previously discussed.

The method ends in step 314.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

I claim:

1. A method for distributing at least one special privilege to an attendee at an event hosted at a geographic location, comprising:
automatically downloading a digital media associated with said at least one special privilege exclusively to a mobile wireless device that is present at said geographic location.

2. The method according to claim 1, further comprising receiving information from said attendee in advance of said event including a unique identifier for identifying a particular said mobile wireless device associated with said attendee.

3. The method according to claim 2, further comprising selecting said unique identifier to include an international mobile equipment identity (IMEI) number, a serial number of said device, and a cellular telephone number assigned to the mobile wireless device.

4. The method according to claim 3, further comprising prior to said automatically downloading step, verifying that said mobile wireless device present at said geographic location is assigned said unique identifier.

5. The method according to claim 1, further comprising selecting said wireless device from the group consisting of a personal digital assistant, a wireless mobile telephone handset, and a personal computer.

6. The method according to claim 1, further comprising confirming a presence of an attendee at an event by detecting a presence of a ticket issued to said attendee for said event, which ticket contains encoded information.

7. The method according to claim 6, further comprising prior to said automatically downloading step, verifying that said ticket has been presented at said event.

8. The method according to claim 1, further comprising selecting said digital media to include a digital rights management (DRM) object.

9. The method according to claim 8, further comprising selecting said DRM object to include an access code which said user can use to access said special privilege.

10. The method according to claim 1, further comprising selecting said special privilege from the group consisting of an audio recording, an audio/video recording, a ring tone, a coupon, a data compilation, and a special ability in an on-line game.

11. A method for distributing at least one special privilege to an attendee at an event, comprising:
selecting at least one special privilege to be offered to an attendee at an event occurring at a geographic location;
automatically downloading a digital media associated with said at least one special privilege exclusively to a mobile wireless device that is present at said geographic location.

12. The method according to claim 11, further comprising receiving information from said attendee in advance of said event including a unique identifier for identifying a particular said mobile wireless device associated with said attendee.

13. The method according to claim 12, further comprising selecting said unique identifier to include an international mobile equipment identity (IMEI) number, a serial number of said device, and a cellular telephone number assigned to the mobile wireless device.

14. The method according to claim 13, further comprising prior to said automatically downloading step, verifying that said mobile wireless device present at said geographic location is assigned said unique identifier.

15. The method according to claim 11, further comprising selecting said wireless device from the group consisting of a personal digital assistant, a wireless mobile telephone handset, and a personal computer.

16. The method according to claim 11, further comprising confirming a presence of an attendee at an event by detecting a presence of a ticket issued to said attendee for said event, which ticket contains encoded information.

17. The method according to claim 16, further comprising prior to said automatically downloading step, verifying that said ticket has been presented at said event.

18. The method according to claim 11, further comprising selecting said digital media to include a digital rights management (DRM) object.

19. The method according to claim 18, further comprising selecting said DRM object to include an access code which said user can use to access said special privilege.

20. The method according to claim 11, further comprising selecting said special privilege from the group consisting of an audio recording, an audio/video recording, a ring tone, a coupon, a data compilation, and a special ability in an on-line game.

21. A mobile wireless device, comprising:
a processor and software application interfacing with a remote computer exclusive of the wireless mobile electronic device;
wherein the remote computer wirelessly automatically downloads a digital media to the wireless mobile device at a geographic location of an event.

22. The mobile wireless device of claim 21, further comprising a data store for storing the digital media.

23. The mobile wireless device of claim 21, further comprising a unique identifier associated exclusively with the mobile wireless device.

24. The mobile wireless device of claim 23, wherein the unique identifier includes an international mobile equipment (IMEI) number, a serial number of the mobile wireless device, and a cellular telephone number assigned to the mobile wireless device.

25. The mobile wireless device of claim 21, wherein said mobile wireless device is a member of the group consisting of a personal digital assistant, a wireless mobile telephone handset, and a personal computer.
